(19) United States
(12) Patent Application Publication
(10) Pub. No.: US 2015/0089983 A1
(43) Pub. Date: Apr. 2, 2015

(54) Lock Mechanism with a Key Removal Interlock and an Interlock of Key Removal from a Lock Mechanism

(71) Applicant: Artur Litwinski, Warszawa (PL)

(72) Inventor: Artur Litwinski, Warszawa (PL)

(21) Appl. No.: 14/500,242

(22) Filed: Sep. 29, 2014

(30) Foreign Application Priority Data
Sep. 30, 2013 (PL) 405 478

(51) Int. Cl. E05B 27/00

(52) U.S. Cl. CPC E05B 27/0003
USPC 70/352

(57) ABSTRACT

It is the object of this invention to provide a lock mechanism with a key removal interlock, and an interlock of key removal from a lock mechanism, for locks with a cylinder, enabling removal of the key from the lock in only one angular position. A lock mechanism with a key removal interlock, comprising a cylinder 1 with two concentric sleeves, an inner sleeve 2 and an outer sleeve 3, with locking components 5 radially arranged angularly in rows 4 along the axis of the cylinder 1 and positioned in channels 6 formed in the inner sleeve 2 and the outer sleeve 3, unlocked with a cylindrical key with an internal guiding bore and positioned on the key outer surface decoding elements, is characterized in that at least two radially arranged angularly rows 4 of locking components 5 are positioned in the inner sleeve 2 and the outer sleeve 3 with different angular spacing. An interlock of key removal from a lock mechanism, comprising a cylinder 1 with two concentric sleeves, an inner one 2 and an outer one 3, with locking components 5 radially arranged angularly in rows 4 along the axis of the cylinder 2 and positioned in channels 6 formed in the inner sleeve 2 and the outer sleeve 3, unlocked with a key with a cylindrical shank with an internal guiding bore and positioned on the outer key surface decoding elements, is characterized in that at least in one row 4 of locking components 5 the number of channels 6 is different than in the remaining rows 4 of locking components 5.

It is the object of this invention to provide a lock mechanism with a key removal interlock and an interlock of key removal from a lock mechanism, for lock with a cylinder, enabling key removal in only one angular position.

Lock mechanisms are known where in lock and cylinder bolts mechanisms there are two cooperating sleeve elements in a form of a cylinder, namely an outer sleeve and an inner sleeve. The lock mechanism is housed in a box provided with a gripping part and at least one bolt. In both sleeves radial openings are formed in which locking elements in a form of spring-supported pins are seated. The locking pins are so sized that in a state without a key there is no possibility to rotate the inner sleeve relative to the outer sleeve, and thus to open the lock.

In known lock and cylinder bolt mechanisms, rotation of the internal sleeve relative to the outer sleeve is possible upon setting the positioning of the locking elements in a position where the locking elements are aligned along a division line of both sleeves and this enables rotation of one sleeve relative to the other one and unlocking of the lock.

Such lock mechanisms have locking elements arranged in rows, for example in four rows, spaced radially at 90°. With the mechanism of such a lock a key cooperates that has a cylindrical shank and encoding recesses arranged on its cylindrical surface that set correspondingly the locking elements in the lock mechanism in a form of pins. In order to prevent the pins of locking elements from falling into the inner sleeve in its longitudinal axis a guide is inserted in a form of a shaft fixed to the base of the cylinder.

A disadvantage of this solution is a possibility of removing the key from the lock after its insertion in any of four angular orientations of the outer sleeve relative to the inner sleeve, corresponding to positioning of rows of locking elements in the lock cylinder. This may cause irregularities in locking of the lock, malfunctioning or damage thereof.

It is the object of this invention to provide a solution for a lock mechanism that makes it possible to avoid the above mentioned disadvantages.

A lock mechanism with a key removal interlock according to the invention comprises a cylinder with two concentric sleeves, outer sleeve and inner sleeve, with locking components radially arranged in rows along with the cylinder axis and embedded in channels formed in the inter sleeve and the outer sleeve. The mechanism is unlocked with a key with a cylindrical shank with an internal guiding bore and decoding elements positioned on the outer key surface, cooperating with the locking components. At least two radially angularly spaced rows of locking components are arranged in the inner and outer sleeves 3 with different angular spacing.

Preferably, the angular difference of asymmetric positioning of the rows of locking components is 1° to 5°.

An interlock of key removal from a lock mechanism according to the invention, where the lock comprises a cylinder with two concentric sleeves, inner sleeve and outer sleeve, with locking components radially arranged angularly in rows along the cylinder axis, positioned in channels formed in the inner and outer sleeves. The mechanism is unlocked with a key with cylindrical shank with internal guiding bore and decoding elements positioned on the outer key surface that cooperate with locking components. At least in one row of locking components the number of channels is different than in the remaining rows 4 of locking components.

### BRIEF DESCRIPTION OF THE DRAWINGS

The object of the invention is shown in embodiments in the drawing, where

FIG. 1 shows a cylinder of a lock mechanism in longitudinal section.

FIG. 2 shows a cylinder of a lock mechanism in cross-section.

FIG. 3 shows an extension of internal surface of the outer sleeve of a cylinder.

### DETAILED DESCRIPTION

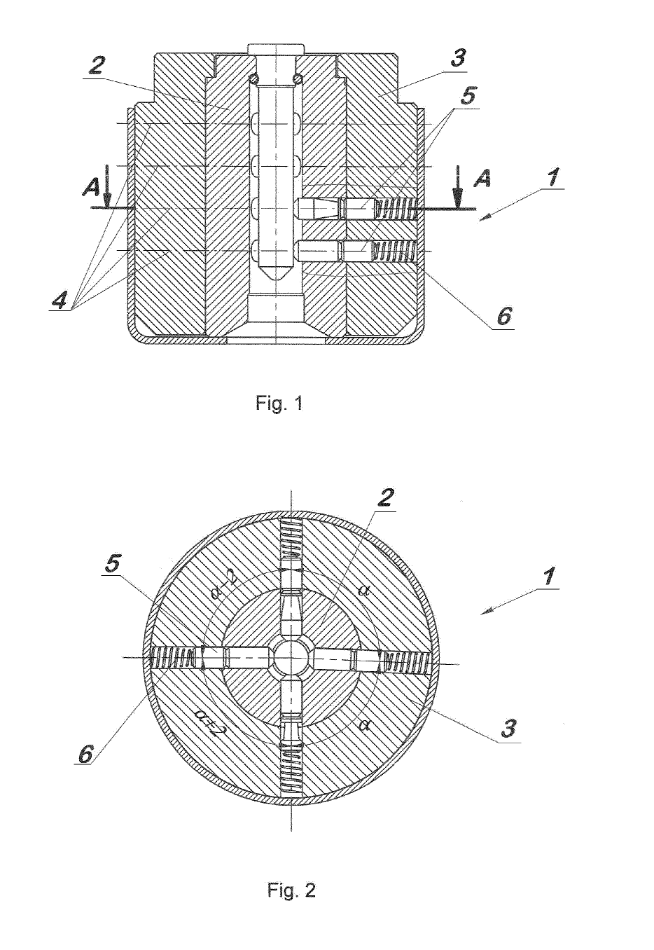

FIGS. 1 and 2 show a lock mechanism with a key removal interlock and an interlock of key removal from a mechanism that has a gripping part (not shown) seated on a box (not shown) where two horizontal bolts (not shown) are inserted as well as a cylinder 1.

The cylinder 1 has two sleeves, inner sleeve 2 and outer sleeve 3, positioned coaxially with a central bore. In the sleeves of the cylinder 5, there are radially positioned in rows in openings 4 locking components 5 in a form of pins supported on springs 6. In the embodiment shown at the perimeter of the inner sleeve 2 and at the perimeter of the outer sleeve 3 there are formed four rows of openings 4 in which locking components 5 are positioned in a form of pins supported on springs 6.

In the central bore of the cylinder 1 there is axially positioned a guide used to guide a cylindrical key and to support locking components when the key is not inserted in the central bore.

As shown in FIG. 2, in a lock mechanism with a key removal interlock, one of the rows of openings 4 where locking components 5 are positioned is shifted angularly relative to the preceding one in the rotational direction to the axis of the cylinder 1 so that this angle is 90°-2° and with regard to the following row of openings 4 where locking components 5 are placed by an angle of 90°+2°. Such angular shift is maintained for the angularly corresponding rows of opening 4 of the cylinder of the encoding recesses on the cylinder key shank which is intended for this lock. This angular shift causes that the key can be removed in only one angular position of the inner sleeve 2 of the cylinder 1 relative to the outer sleeve 3 of the cylinder 1, where the angular shifts on the key will coincide with the angular shifts of the inner sleeve 2 and the outer sleeve 3 of the cylinder 1.

In the remaining three angular positions the locking components 5 positioned in rows of openings 4 will make it impossible to remove the key, since they will lock the encoding recesses of the key.

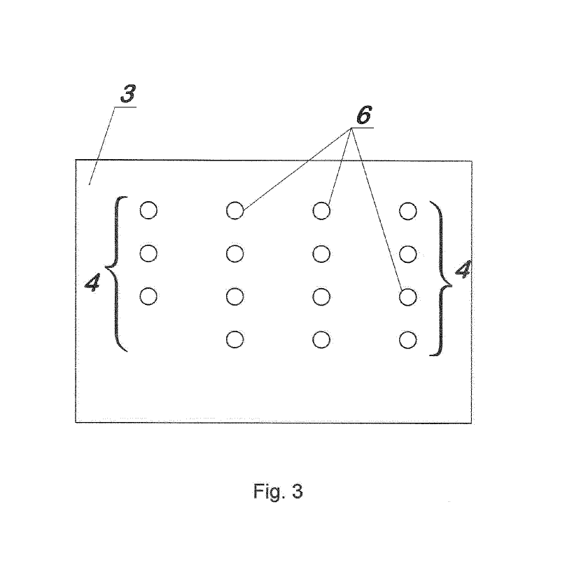

As shown in FIG. 3, in a further embodiment, in an interlock of key removal from a lock mechanism according to the second invention, one of openings 4 in one of rows of openings 4 in which locking components 5 are seated has been eliminated. This opening is absent from the row of openings both in the inner sleeve 2 and in the outer sleeve 3. Absence of one opening 4 for locking components is visible in the extension in FIG. 3 in the outer left-hand row of the extension. If the cylinder is in one of the four positions where the rows of openings 4 for locking elements 5 in the inner sleeve 2 are in one line with the rows of openings 4 for locking elements 5 in the outer sleeve 3, and the row of openings 4 of a lower number of openings 4 in the inner sleeve 2 is not in one line with the row of openings 4 of a lower number of openings 4 in the outer sleeve 3, then the key cannot be removed from the lock, since this is prevented by the locking components 5 in a form of pins supported on springs 6 that in this position have no space to “hide” and thus they will lock the key in its encoding recesses.

I claim:

1. A lock mechanism with a key removal interlock, comprising a cylinder 1 with two concentric sleeves, an internal sleeve 2 and an outer sleeve 3, with locking components 5 radially arranged angularly in rows 4 along the axis of the cylinder 1 and arranged in channels 6 made in the inner sleeve 2 and the outer sleeve 3, unlocked with a key with a cylindrical shank with an internal guiding bore and with decoding elements arranged on the outer key surface, characterized in that at least two radially arranged angularly rows 4 of locking components 5 are positioned in the inner sleeve 2 and the outer sleeve 3 with different angular spacing.

2. A lock mechanism according to claim 1 characterized in that the angular difference of asymmetric arrangement of rows 4 of locking components 4 is 1° do 5°.

3. An interlock of key removal from a lock mechanism comprising a cylinder 1 with two concentric sleeves, an inner sleeve 2 and an outer sleeve 3 with radially arranged angularly in rows 4 along the axis of the cylinder 2 locking components 5 arranged in channels 6 formed in the inner sleeve 2 and the outer sleeve 3 unlocked with a key with a cylindrical shank with an internal guiding bore and positioned on the outer key surface decoding elements, characterized in that at least in one row 4 of locking components 5 the number of channels 6 is different than in the remaining rows 4 of locking components 5.
